(19) United States
(12) Patent Application Publication
(10) Pub. No.: US 2024/0001562 A1
(43) Pub. Date: Jan. 4, 2024

(54) INCIDENT NOTIFICATION SYSTEM FOR A SEMI-AUTONOMOUS CLEANING DEVICE

(71) Applicant: Avidbots Corp, Kitchener (CA)

(72) Inventors: Florin COCA, Cambridge (CA); Resma RATH, Kitchener (CA); Duncan Chapman MCLENNAN, Kitchener (CA); Oriana WONG, Kitchener (CA); Pablo Roberto MOLINA-CABRERA, Waterloo (CA)

(21) Appl. No.: 18/343,974

(22) Filed: Jun. 29, 2023

Related U.S. Application Data
(60) Provisional application No. 63/367,224, filed on Jun. 29, 2022.

(51) Int. Cl. B25J 13/06; A47L 11/40; A47L 9/28; B25J 9/16

(52) U.S. Cl. CPC B25J 13/06; A47L 11/4008; A47L 11/4011; A47L 11/4066; A47L 9/2836; A47L 9/2857; A47L 9/2889; A47L 9/2894; B25J 9/1674; A47L 2201/06; A47L 2201/04

(57) ABSTRACT

A system and method for incident notification for an autonomous or a semi-autonomous cleaning device. The incident notification can be provided with or without videos using hyperlinks. Videos can be accessed directly on the cleaning device graphical user interface (GUI) on the incident notification dashboard. Based on the detected failure types, direct links to specific contextual help videos next to each incident notification can be provided to further troubleshoot the incident. The system simplifies the complexity of incident notification and improves the user experience by merging all monitoring on a single dashboard which can manage all simultaneous faults in a coherent manner.

### CROSS REFERENCE TO RELATED APPLICATIONS

The application claims priority to and the benefit of U.S. Provisional Patent Application Ser. No. 63/367,224, entitled “INCIDENT NOTIFICATION SYSTEM FOR A SEMI-AUTONOMOUS CLEANING DEVICE” filed on Jun. 29, 2022, the disclosure of which is incorporated herein by reference in its entirety.

### BACKGROUND

The embodiments described herein relate to semi-autonomous cleaning, in particular incident notification for a semi-autonomous cleaning device for cleaning and disinfection of surfaces.

The use of semi-autonomous devices configured to perform a set of tasks is known. For example, semi-autonomous devices or robots can be used to clean a surface, mow a lawn, collect items from a stocked inventory, etc. In some instances, however, some known robots fail to provide a user with an indication of the robot's position, progress, and/or status of one or more components of the system. For example, the problem of debris accumulation in the back squeegee of a cleaning robot or floor scrubber is a common problem.

Due to regular wear and tear on semi-autonomous devices, or certain exceptional situations that the device may encounter where operator assistance is required, there will be occasions where the device is unable to continue operating normally or safely. To rectify such situations, the operator needs to be informed of the detected issues or “incidents” on the device. Next, they need to be instructed in ways to troubleshoot and resolve these issues including providing tutorials or videos on a graphical user interface (GUI) or dashboard. Finally, once these issues are resolved, the robot needs to be able to resume its normal operation, in continuation of the sequence prior to the failures.

There is a desire to provide a better notification system on semi-autonomous devices to diagnose problems with preferably a better user experience.

### SUMMARY

A system and method for incident notification for an autonomous or a semi-autonomous cleaning device. The incident notification can be provided with or without videos using hyperlinks. Videos can be accessed directly on the cleaning device graphical user interface (GUI) on the incident notification dashboard. Based on the detected failure types, direct links to specific contextual help videos next to each incident notification can be provided to further troubleshoot the incident. The system simplifies the complexity of incident notification and improves the user experience by merging all monitoring on a single dashboard which can manage all simultaneous faults in a coherent manner.

### BRIEF DESCRIPTION OF THE DRAWINGS

FIG. 1 is a perspective view of a semi-autonomous cleaning device.

FIG. 2 is a front view of a semi-autonomous cleaning device.

FIG. 3 is a back view of a semi-autonomous cleaning device.

FIG. 4 is a left side view of a semi-autonomous cleaning device.

FIG. 5 is a right-side view of a semi-autonomous cleaning device.

FIG. 6 is a diagram that illustrates an incident transition page.

FIG. 7 is a diagram that illustrates an incident manual mode screen.

FIG. 8 is a diagram that illustrates an incident autonomous mode screen.

FIG. 9 is a diagram that illustrates an incident mode more info screen.

FIG. 10 is a diagram that illustrates a further incident screen with drive gears.

FIG. 11 is a diagram that illustrates a “low voltage” display screen.

FIG. 12 is a diagram that illustrates a no active faults screen.

FIG. 13 is a diagram that illustrates a manual controls dashboard screen.

FIG. 14 is a line diagram that illustrates a further embodiment of autonomous mode.

FIG. 15 is a diagram that illustrates a further embodiment of manual mode.

FIG. 16 is a flow chart illustrating operation in autonomous and manual mode.

FIG. 17 is a diagram illustrating a Resource Center screen layout.

FIG. 18 is a further diagram illustrating a Resource Center screen.

FIG. 19 is a further diagram illustrating incident notifications.

### DETAILED DESCRIPTION

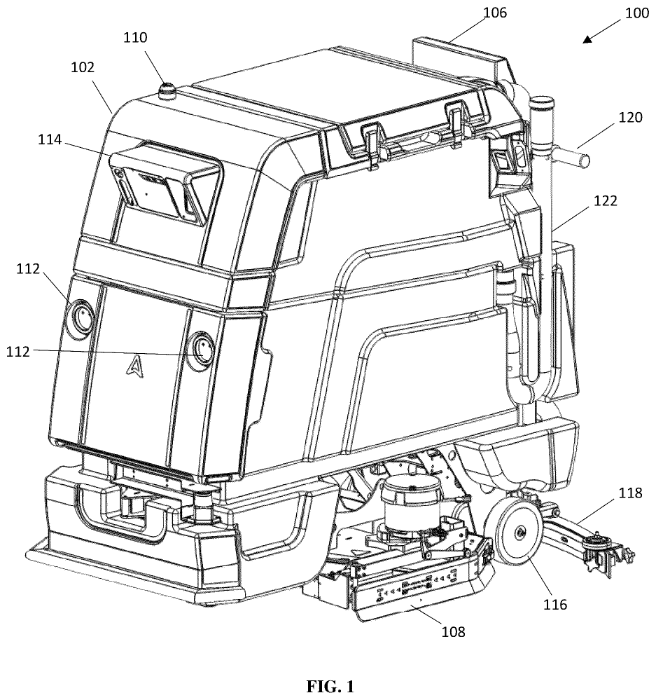

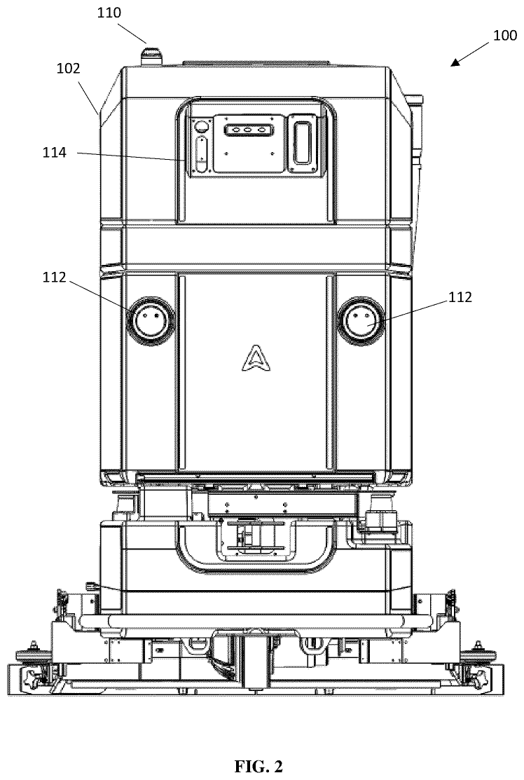

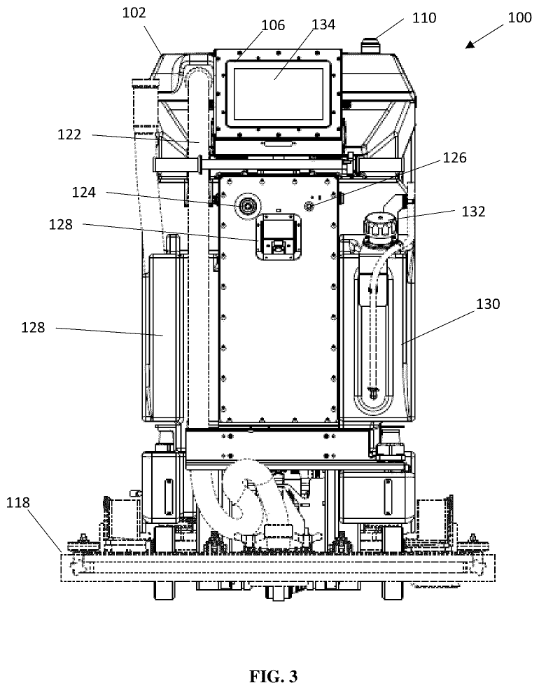

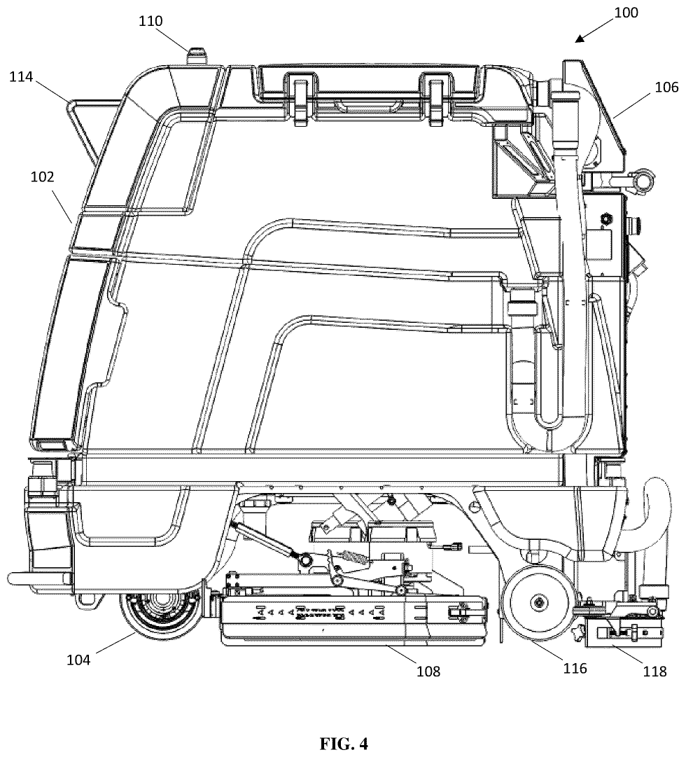

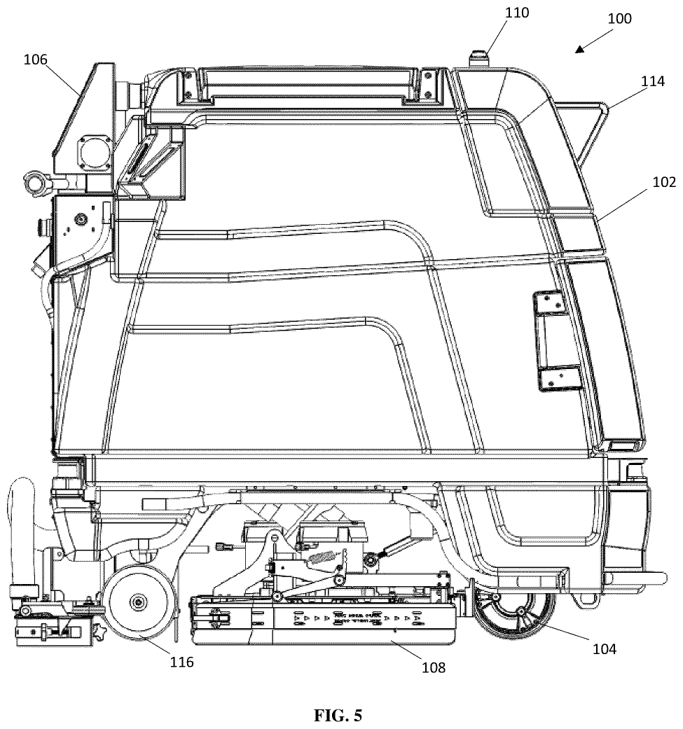

An exemplary embodiment of an autonomous or semi-autonomous cleaning device is shown in FIGS. 1-5. FIG. 1 is a perspective view of a semi-autonomous cleaning device. FIG. 2 is a front view of a semi-autonomous cleaning device. FIG. 3 is a back view of a semi-autonomous cleaning device. FIG. 4 is a left side view of a semi-autonomous cleaning device, and FIG. 5 is a right-side view of a semi-autonomous cleaning device.

FIGS. 1 to 5 illustrate a semi-autonomous cleaning device 100. The device 100 (also referred to herein as “cleaning robot” or “robot”) includes at least a frame 102, a drive system 104, an electronics system 106, and a cleaning assembly 108. The cleaning robot 100 can be used to clean (e.g., vacuum, scrub, disinfect, etc.) any suitable surface area such as, for example, a floor of a home, commercial building, warehouse, etc. The robot 100 can be any suitable shape, size, or configuration and can include one or more systems, mechanisms, assemblies, or subassemblies that can perform any suitable function associated with, for example, traveling along a surface, mapping a surface, cleaning a surface, and/or the like.

The frame 102 of cleaning device 100 can be any suitable shape, size, and/or configuration. For example, in some embodiments, frame 102 can include a set of components or the like, which are coupled to form a support structure configured to support the drive system 104, the cleaning assembly 108, and the electronic system 106. Cleaning assembly 108 may be connected directly to frame 102 or an alternate suitable support structure or sub-frame (not shown). The frame 102 of cleaning device 100 further comprises strobe light 110, front lights 112, a front sensing module 114 and a rear sensing module 128, rear wheels 116, rear skirt 118, handle 120 and cleaning hose 122. The frame 102 also includes one or more internal storage tanks or storing volumes for storing water, disinfecting solutions (i.e., bleach, soap, cleaning liquid, etc.), debris (dirt), and dirty water. More information on the cleaning device 100 is further disclosed in U.S. utility patent application Ser. No. 17/650,678, entitled “APPARATUS AND METHODS FOR SEMI-AUTONOMOUS CLEANING OF SURFACES” filed on Feb. 11, 2022, the disclosure which is incorporated herein by reference in its entirety.

More particularly, in this embodiment, the front sensing module 114 further includes structured light sensors in a vertical and horizontal mounting position, an active stereo sensor and an RGB camera. The rear sensing module 128, as seen in FIG. 3, consists of a rear optical camera. In further embodiments, front and rear sensing modules 114 and 128 may also include other sensors including one or more optical cameras, thermal cameras, LiDAR (Light Detection and Ranging), structured light sensors, active stereo sensors (for 3D) and RGB cameras.

The back view of a semi-autonomous cleaning device 100, as seen in FIG. 3, further shows frame 102, cleaning hose 122, clean water tank 130, clean water fill port 132, rear skirt 118, strobe light 110 and electronic system 106. Electronic system 106 further comprises display 134 which can be either a static display or touchscreen display. Rear skirt 118 consists of a squeegee head or rubber blade that engages the floor surface along which the cleaning device 100 travels and channels debris towards the cleaning assembly 108.

FIG. 3 further includes emergency stop button 124 which consists of a big red button, a device power switch button 126 and a rear sensing module 128. Rear sensing module 128 further comprises an optical camera that is positioned to sense the rear of device 100. This complements the front sensing module 114 which provides a view and direction of the front of device 100, which work together to sense obstacles and obstructions. More information on the semi-autonomous devices can be found in U.S. Utility patent application Ser. No. 17/650,678, entitled “SYSTEM AND METHOD OF SEMI-AUTONOMOUS CLEANING OF SURFACES”, filed on Feb. 11, 2022, the disclosure of which is incorporated herein by reference in their entirety.

While the semi-autonomous cleaning device 100 as shown in FIGS. 1-5 is the preferred embodiment of a host device for the incident notification system, any other semi-autonomous cleaning device may be a host device for the incident notification system as disclosed. In addition, it is contemplated that other semi-autonomous devices, such as semi-autonomous security/surveillance robots, semi-autonomous customer-service kiosks/robots or entertainment-related semi-autonomous devices, may be suitable host devices for similar or related embodiments of an incident notification system. In the cases of hosting on the latter devices, it is understood that relevant modifications would need to be made to the incident notification system as disclosed here.

In further embodiments (not shown), the semi-autonomous cleaning device further comprises a radio transmitter and receiver including a cellular connection or a WiFi© connection that enables the cleaning device to communicate wirelessly with the Internet to provide info on incident notification and/or fetch data from the Internet. For example, if there is a video hyperlink, the apparatus can retrieve and download the video from the Internet and store the video locally or enable viewing of the video in real-time.

### Incident Notification System

The incident notification system is a series of graphical user interface (GUI) screens shown on display 134 to provide notification to the user of the operation of the device. The incident notification system includes at least some of the following features:
Consolidates multiple failures detected by the various health monitoring systems (safety, diagnostics) on the robot, into one convenient notification screen on the robot.
Incorporates into health monitor system of the device whereby the incident notification system consolidates the notifications generated by the safety monitor (e.g., includes the localization monitor, tracking monitor, safety zones, and system integrity), health monitor and advanced diagnostics into a harmonized dashboard, allowing multiple failures to be presented simultaneously. Prior to this, only one notification from any of these monitoring systems would appear on screen at a given time.
The screen appears when 1 or more failures occurs.
The notification screen uses color-coding plus warning/information icons generated by the device's general purpose (i.e., main) computer and rendered to a high-resolution LCD Touchscreen display 134 to indicate the severity of each failure. Colour-coding may further indicate the type of feedback that measures the failure (and therefore how the operator might need to go about inspecting for it/resolving it).
Provides an error code to help troubleshoot issues with customer service.
Sorts incidents by severity.
Allows operators to address failures one at a time and view their status in real time.
Operators can expand/collapse details by pressing on the incident.
Can see if errors are cleared by pressing the Resume Plan button to resume autonomous operation of the device.
Automatically updates the reported failure states when they change.
Operator can move the robot using on-screen controls if it is in a safe state to do so, to help place the robot in a position better suited for troubleshooting, etc.
Additionally, an “active alerts” icon in the top banner (alarm bell icon) with the number of active incidents indicated beside it.
These screens are only accessible if the user has entered the correct passcode, to prevent tampering.
Synchronizes these alerts to a cloud management system, for remote assistance and logging, and also provides automated alerts to operators via SMS, e-mail etc. options as it applies to relevant situations.

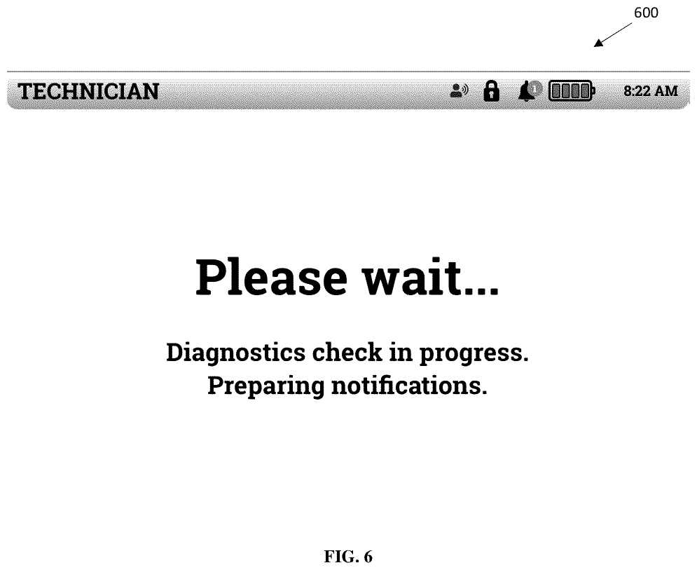

According to the disclosure, FIGS. 6 to 13 illustrate different examples of GUI screens of the incident notification system. FIG. 6 is a diagram that illustrates an incident transition page. According to FIG. 6, the incident transition page 600 is displayed while the semi-autonomous device is being neutralized (e.g., cleaning systems disengaged) after a fault occurs. A message such as “Please wait . . . Diagnostic check in progress. Preparing notifications.” Is shown on display 134. The device is paused (i.e., stopped) and the user cannot interact with it at this time.

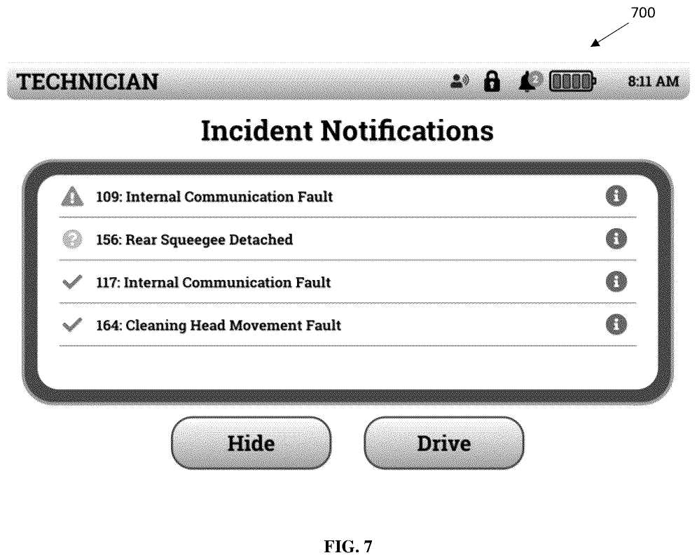

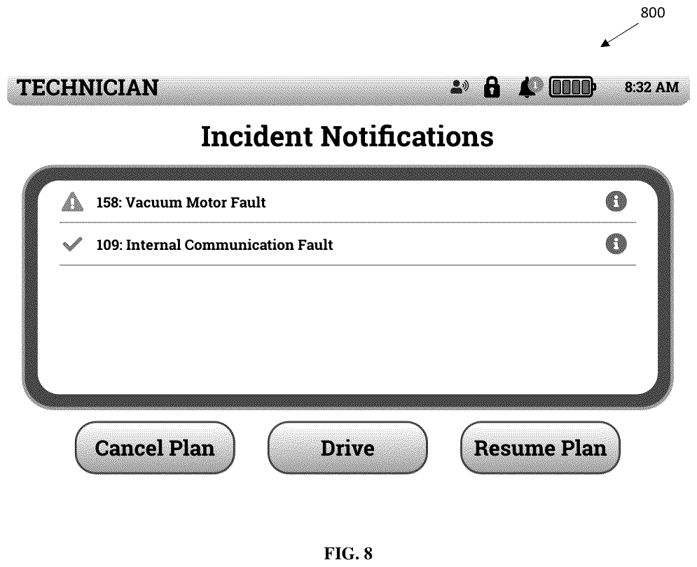

FIG. 7 is a diagram that illustrates an incident manual mode screen. FIG. 8 is a diagram that illustrates an incident autonomous mode screen. According to FIGS. 7 and 8, display screen 700 and 800 displays each incident status. Orange exclamation indicates an active fault. A yellow question mark indicates an unknown state and a green check indicates cleared faults.

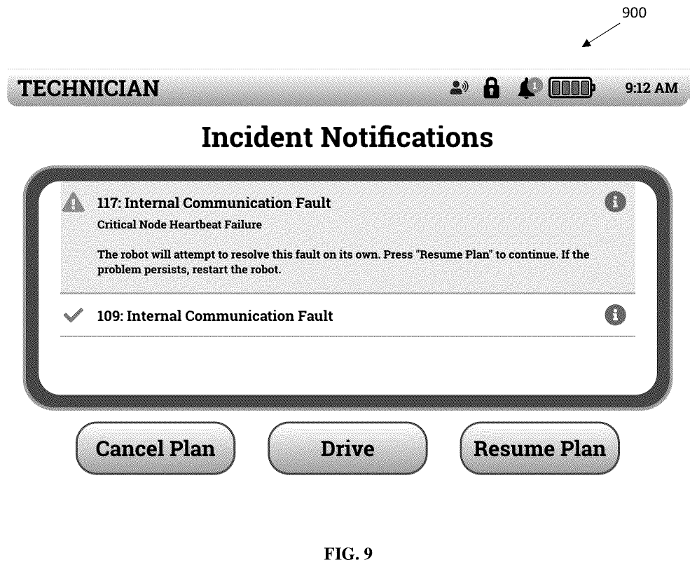

FIG. 9 is a diagram that illustrates an incident mode more info screen 900. Whether in manual mode (FIG. 7) or autonomous mode (FIG. 8), selecting a specific incident will display a longer description. According to FIG. 9, selecting “117: Internal Communication Fault” will display that this incident relates to “Critical Node Heartbeat Failure” wherein the device will attempt to resolve this fault on its own. The user would be required to press the “Resume Plan” to continue. Furthermore, if the problem persists, the user would be required to restart the device.

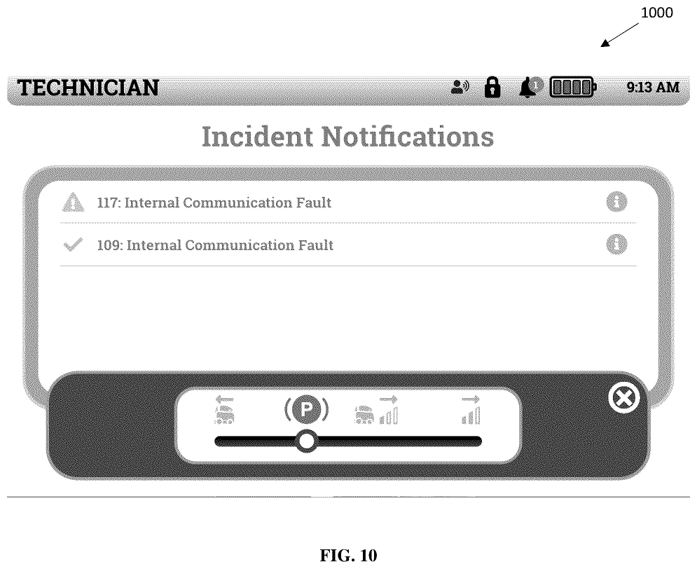

FIG. 10 is a diagram that illustrates a further incident screen 1000 with drive gears. Whether in manual mode (FIG. 7) or autonomous mode (FIG. 8), selecting the drive button will display the drive gears. According to FIG. 10, the drive gears illustrate reverse direction, parked and forward direction with various speeds (e.g., slow, medium, fast). In further embodiments, the drive gear screen will not show the drive gears if there is an active Main Control Unit (MCU) Activity Fault. The Main Control Unit (MCU) is a separate microcontroller board that controls the various pumps & motors on the robot and receives measurement feedback from basic sensors like water level and current. An MCU Activity Fault would indicate something wrong with the communication between the main PC and the MCU and may include disconnection, failed MCU and/or unrecognized firmware.

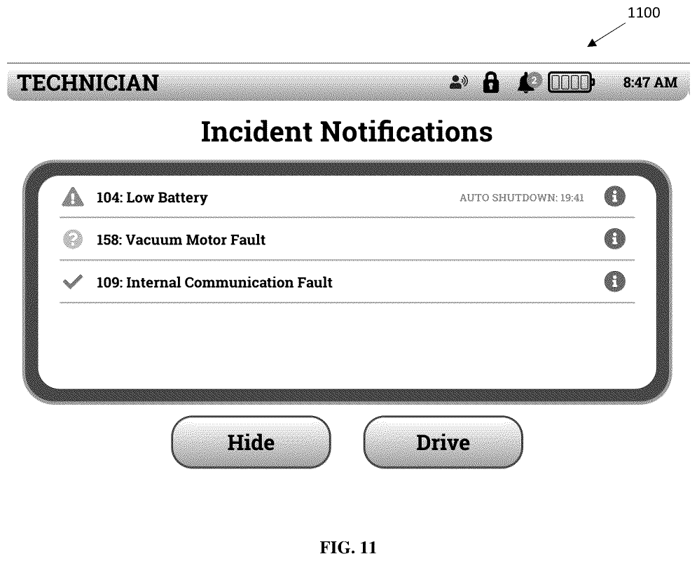

FIG. 11 is a diagram that illustrates a “low voltage” display screen 1100. According to FIG. 11, the “low voltage” (or low battery) fault displays a special message, showing how long the robot has before initiating shutdown. For example, FIG. 11 indicates that there is a low battery and the device will do an “auto shutdown” in 19 minutes, 41 seconds.

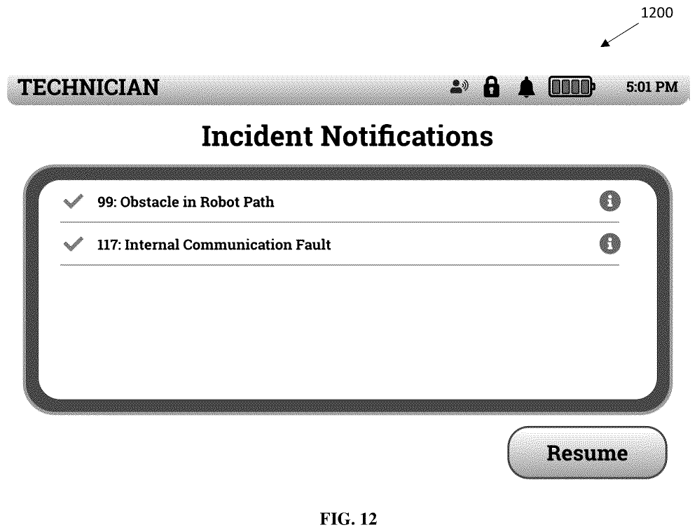

FIG. 12 is a diagram that illustrates a no active faults screen 1200. According to FIG. 12, display 134 will not display any active faults (e.g., all check marks). Furthermore, if there are no active faults, the bell icon has no orange circle.

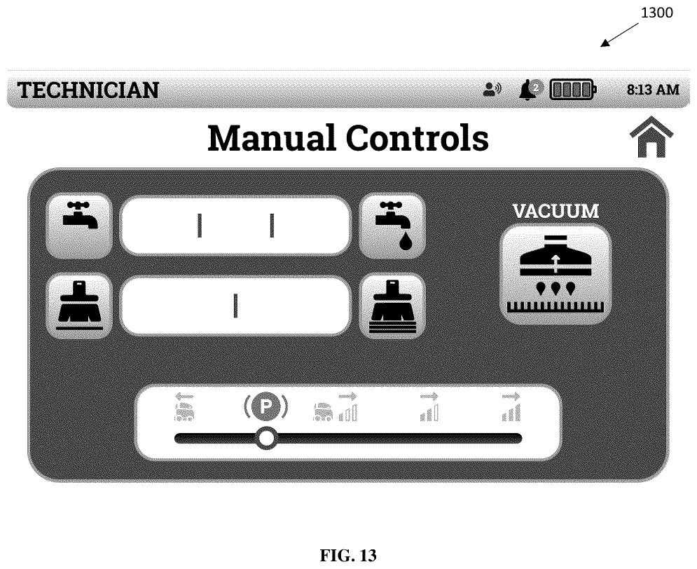

FIG. 13 is a diagram that illustrates a manual controls dashboard screen 1300. According to FIG. 13, the manual controls dashboard displays icons illustrating a speed mode of the device (e.g., currently in parked), water level, cleaning intensity, vacuum on/off, battery level and number of incident alerts (e.g., bell icon showing 2 incident alerts). According to FIG. 13, the bell icon remains even if the user navigates away from the incident page. The number on the bell icon is the number of faults in active or unknown status.

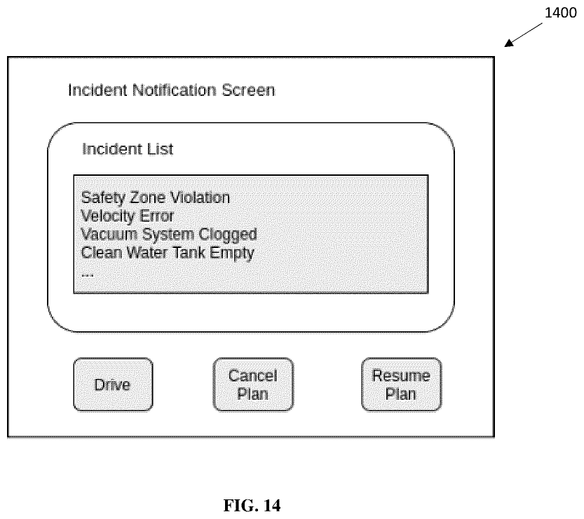

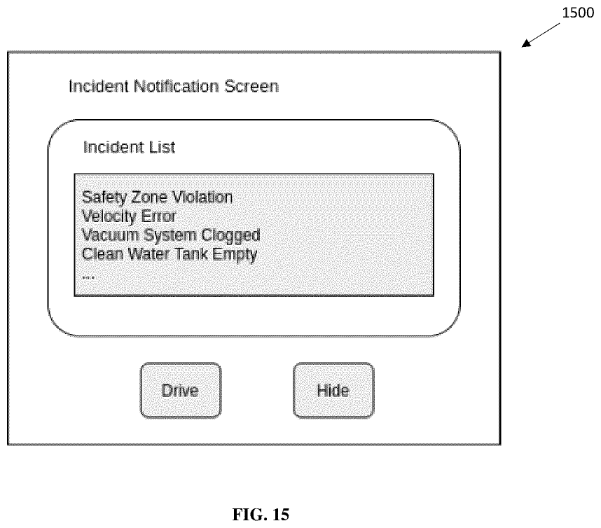

FIG. 14 is a line diagram that illustrates a further embodiment of an autonomous mode screen 1400. FIG. 15 is a diagram that illustrates a further embodiment of a manual mode screen 1500. According to FIGS. 14 and 15, in both Autonomous and Manual modes, all faults are presented in a scrollable list. A “Drive” button displays a drive gear box allowing the user to drive the robot, assuming the drive system is accessible and functional.

According to FIG. 14, in Autonomous mode, the user is presented with the option to cancel the current plan or resume the plan once all active faults have been cleared. According to FIG. 15, in Manual mode, the user may hide the screen in order to be able to access other functions of the robot that may not be affected by the current faults. Furthermore, in both modes, a “bell” notification icon is present in the status bar indicating how many active faults are present at the time.

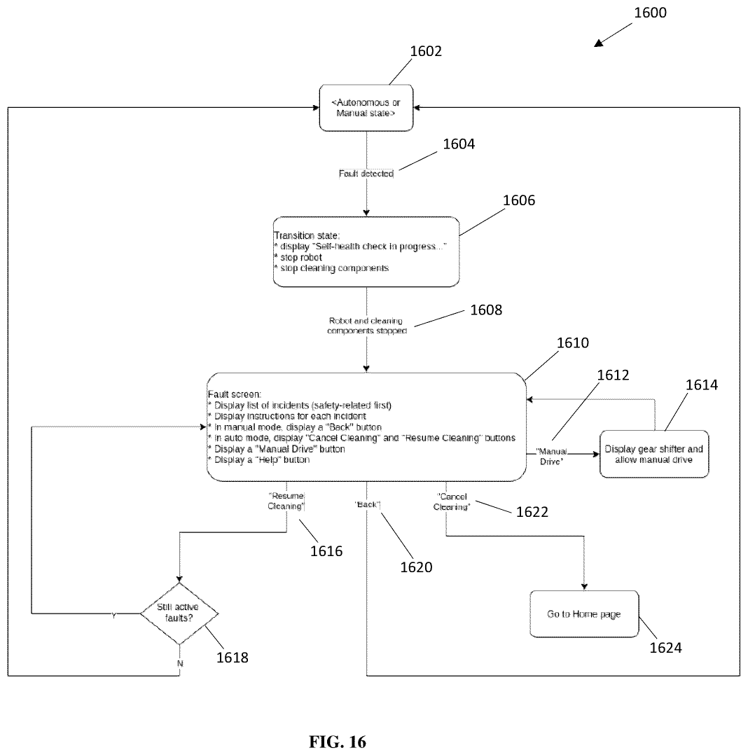

FIG. 16 is a flow chart illustrating operation in autonomous and manual mode. According to FIG. 16, the flow chart 1600 starts by detecting whether it is in autonomous or manual mode at step 1602. When a fault is detected at step 1604, the cleaning device enters a transition state at step 1606 during which the device is commanded to stop and all of its active cleaning components are turned off. This transition state is necessary due to the non-trivial amounts of time various components need to turn off and complete the transition to fault state.

During the transition period, a message is displayed indicating to local users that the device has detected one or more incidents and it is processing them. The transition state will also display a message such as “self-health check in progress”. In order to prevent undefined states and behaviour, the device does not accept any local or remote user commands and the device and cleaning components are stopped at step 1608.

According to FIG. 16, the device continues to monitor for new faults or E-Stop conditions. According to the disclosure, E-stop generally refers to a stop caused by pressing the large red button (e.g., emergency stop button), as well as other conditions that may cause a similar effect (e.g., an obstacle hitting the front bumper). Once the device is stopped and the hardware components are in a neutral state, an incident screen (or fault screen) is displayed listing all of the currently detected faults with additional information available for each.

According to FIG. 16, the incident or fault screen at step 1610 may display the following messages:
Display list of incidents (safety-related first)
Display instructions for each incident
In manual mode, display a “Back” or “Hide” button
In auto mode, display “Cancel Cleaning” and “Resume Cleaning” buttons or “Cancel” and “Resume” buttons
Display a “Manual Drive” button
Display a “Help” button

According to FIG. 16, after the fault screen, the user is presented with different options. If “Manual Drive” is selected at step 1612, the device displays the gear shifter at step 1614 and allows manual drive and then returns to the fault screen. If “Resume cleaning” is selected at step 1616, the device checks to see if faults are still active at step 1618 If not, the flow chart returns to the start (autonomous or manual state) at step 1602. If there are active faults, the flow chart returns to the fault screen at step 1610. If “Back” is selected at step 1620, the flow chart returns to the start (autonomous or manual state) at 160. Finally, if “Cancel Cleaning” is selected at step 1622, the flow chart returns to the home page at step 1624.

According to FIG. 16, the user may address user-addressable incidents. The following process flow illustrates action related to a user-addressable incident. For example, if an “unclog vacuum hose” incident is reported, then:
if the device is in autonomous mode (i.e., cleaning autonomously):
   press “Resume Plan”:
      If faults are still active, no action is taken
      If no active faults exist, the device goes to its previous state
   If press “Cancel Plan”:
      the current plan is cancelled
      a report is generated.
If the device is manual mode:
   Press “Hide”:
      The device goes into the previous state, and
      an incident icon is displayed in the status bar
In both manual and autonomous modes:
   Presses “Drive”:
      a gear shifter popup is displayed that allows the user to drive the robot manually (assuming the drive system is functional)
When the incident icon in the status bar is pressed, the incident screen is displayed again.

According to FIG. 16, if a fault is detected during the transition state it will be added to the list of faults that will be displayed in the incidents screen, but no extra action is taken unless it is an E-stop, in which case the robot movement is stopped instantly, and the cleaning components continue to be turned off.

According to FIG. 16, if a fault happens while the robot is on the incidents screen, the fault will be added to the list and no further action is taken. If a fault clears (i.e., the conditions that triggered the fault disappear either as a result of a user action or as a result of self-changing conditions such as CPU load dropping), the fault is marked as cleared in the incidents screen.

### Resource Center

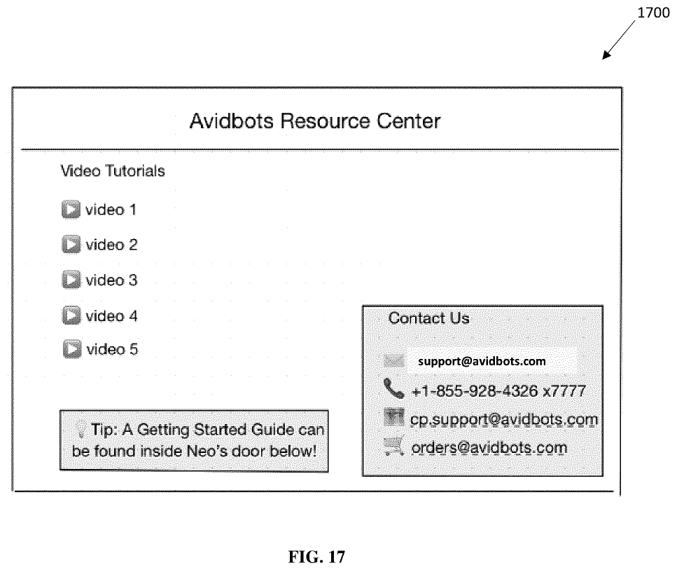

According to the disclosure, the semi-autonomous device also provides a resource center with a plurality of help or self-help videos. FIG. 17 is a diagram illustrating a Resource Center screen layout 1700. According to FIG. 17, the layout of a Resource Center screen will include a list of video tutorials, a box to provide contact info (e.g., email and phone number for support and orders) and a tip area.

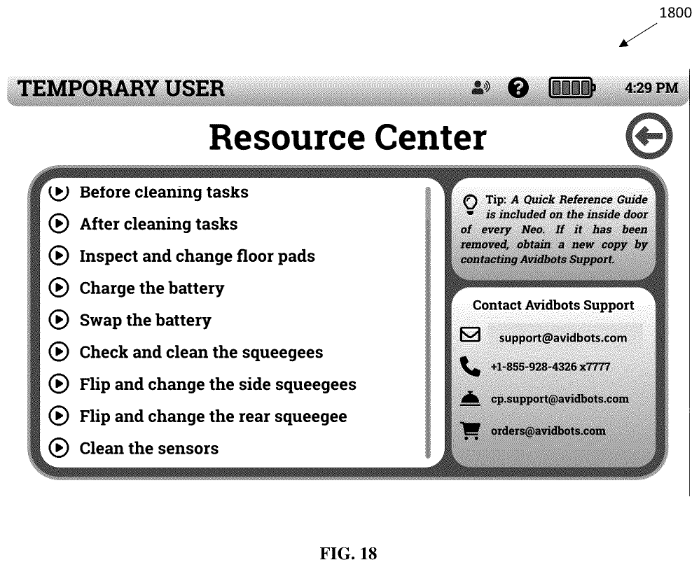

FIG. 18 is a further diagram illustrating a Resource Center screen 1800 showing videos, tips and support contact info.

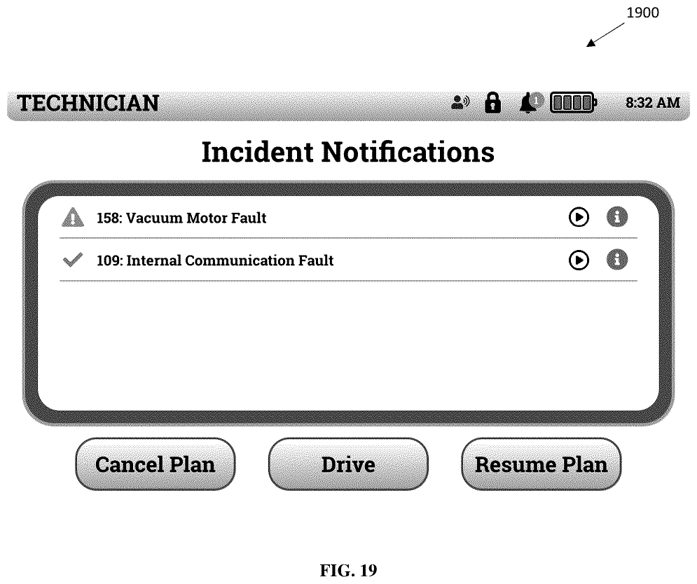

FIG. 19 is a further diagram illustrating incident notifications screen 1900. According to FIG. 19, the automatic association of each incident is linked (or associated) to a pertinent help resource, rather than the static list of videos.

According to the disclosure, features of the resource center include:
Contextual Help Videos are presented in a full list accessed via a button in a separate menu, instead of situationally alongside an incident on the incident notification screen.
Videos will be shown on the device named “Resource Center” and on the Avidbots website.
Based on the detected failure types, provide direct links (via button or similar) to specific contextual help videos next to each incident notification as shown in FIG. 19.
Videos can be accessed directly on the robot GUI on the incident notification dashboard.
Videos are stored in the local filesystem and can be synchronized from a cloud-based repository of videos that have assistive content specific to the robot version, software version, robot configuration, equipped add-ons, etc.
This allows operators to quickly understand how to troubleshoot and address the specific detected failures.

According to the disclosure, some examples of self-help videos include:
squeegee attachment error can show video(s) on how to install squeegee, check squeegee sensors, etc.,
sensor noise errors can show video on how to clean lidar and camera sensors as appropriate

According to the disclosure, the video tutorials may be pre-downloaded and stored on the cleaning device, however, options may exist to enable future video downloads from a cloud/online archive. Future upgrades or maintenance downloads may trigger download of all videos or specific videos. Video tutorials may be indexed and categorized for storage on the cleaning device and easy retrieval for future use.

Contextual help exists in many software applications, operating systems, etc. that provide help links to relevant material to assist in troubleshooting issues, though this may or may not come with self-diagnostics.
Also known as context-sensitive help and can take the form of tooltips.
This can go as far as a live chat window to a remote support person.
A one-way message pop-up that allows the remote person to type out custom messages describing what might need to be fixed, which gets displayed on the robot GUI.

Further differentiation is the combination of the cleaning machine device with self-diagnostics and contextual help videos automatically associated and presented with each incident.

According to the disclosure, a computer-implemented method for providing incident notification for a semi-autonomous cleaning apparatus is disclosed. The method comprising the steps of detecting a fault at the apparatus, when a fault is detected, placing the apparatus in a transition state whereby all active cleaning components are turned off, rebooting the apparatus and performing a self-diagnostic check, displaying a fault or incident screen with different menu options, receiving input from the user on the menu options, providing instructions to the processor of the apparatus to execute on an action related to the input and clearing the fault and resume operation when the fault is cleared.

According to the disclosure, computer-implemented method further comprises the step of detecting whether the apparatus is operating in automatic or manual mode and displaying a message that a diagnostic check is in progress. The message for the diagnostic check displays a message that a self-health check is in progress.

According to the disclosure, the menu options of the computer-implemented method are selected from list consisting of displaying list of incidents (safety-related first), displaying instructions for each incident, in manual mode, displaying a “Back” or “Hide” button, in auto mode, displaying “Cancel Cleaning” and “Resume Cleaning” buttons or “Cancel” and “Resume” buttons, displaying a “Manual Drive” button and displaying a “Help” button.

According to the disclosure, the “Manual Drive” option is selected, the apparatus displays the gear shifter icon and allows manual drive and then returns to the fault screen. The “Resume cleaning” option is selected, the device checks to see if faults are still active and returns to the fault screen.

According to the disclosure, If the “Back” button is selected in the method, the workflow returns to the start (autonomous or manual state). If the “Cancel Cleaning” button is selected in the method, the screen returns to the home page. According to the disclosure, the action can also be configured to address user-addressable incidents.

According to the disclosure, if a fault is detected during the transition state it will be added to the list of faults that will be displayed in the incidents screen, but no extra action is taken unless it is an E-stop, in which case the robot movement is stopped instantly, and the cleaning components continue to be turned off.

According to the disclosure, if a fault clears (i.e., the conditions that triggered the fault disappear either as a result of a user action or as a result of self-changing conditions such as CPU load dropping), the fault is marked as cleared in the incidents screen.

According to the disclosure, the incident notification of the method can be provided with or without videos using hyperlinks based on the detected failure types, the hyperlinks are configured to specific contextual help videos next to each incident notification to further troubleshoot the incident. The videos can be accessed directly on the cleaning device graphical user interface (GUI) on the incident notification dashboard.

According to the disclosure, an incident notification system for providing incident notification for a semi-autonomous cleaning apparatus is disclosed. The incident notification system comprises a processor, a display screen and memory configured to store data related to incident notification.

According to the disclosure, the processor is configured to execute instructions related to incident notification, the instructions further comprising the steps of detecting a fault at the apparatus, when a fault is detected, placing the apparatus in a transition state whereby all active cleaning components are turned off, rebooting the apparatus and performing a self-diagnostic check, displaying a fault or incident on the display screen with different menu options, receiving input from the user on the menu options, providing instructions to the processor of the apparatus to execute on an action related to the input and clearing the fault and resume operation when the fault is cleared. The stored data is configured to store videos with or without hyperlinks.

According to the disclosure, the system further comprises a wireless receiver and transmitter to support cellular or Wifi® communication. The display screen of the system further comprises a dashboard configured to manage simultaneous faults in a single screen.

According to the disclosure, the processor of the system is further configured to execute the step of detecting whether the apparatus is operating in automatic or manual mode and display a message that a diagnostic check is in progress.

According to the disclosure, the menu options displayed on the system are selected from list consisting of displaying list of incidents (safety-related first), displaying instructions for each incident, in manual mode, displaying a “Back” or “Hide” button, in auto mode, displaying “Cancel Cleaning” and “Resume Cleaning” buttons or “Cancel” and “Resume” buttons, displaying a “Manual Drive” button and displaying a “Help” button.

According to the disclosure, if the “Manual Drive” option is selected in the system, the apparatus displays the gear shifter icon and allows manual drive and then returns to the fault screen. If the “Resume cleaning” option is selected in the system, the device checks to see if faults are still active and returns to the fault screen.

According to the disclosure, If the “Back” button is selected in the system, the workflow returns to the start (autonomous or manual state). If the “Cancel Cleaning” button is selected in the method, the screen returns to the home page. According to the disclosure, if the action can also be configured to address user-addressable incidents.

According to the disclosure, if a fault is detected during the transition state it will be added to the list of faults that will be displayed in the incidents screen, but no extra action is taken unless it is an E-stop, in which case the robot movement is stopped instantly, and the cleaning components continue to be turned off.

According to the disclosure, if a fault clears (i.e., the conditions that triggered the fault disappear either as a result of a user action or as a result of self-changing conditions such as CPU load dropping), the fault is marked as cleared in the incidents screen.

According to the disclosure, incident notification of the system can be provided with or without videos using hyperlinks based on the detected failure types, the hyperlinks are configured to specific contextual help videos next to each incident notification to further troubleshoot the incident. The videos can be accessed directly on the cleaning device graphical user interface (GUI) on the incident notification dashboard.

According to the disclosure, the processor of the system is further configured to execute the step of detecting whether the apparatus is operating in automatic or manual mode.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A computer-implemented method for providing incident notification for a semi-autonomous cleaning apparatus, the method comprising the steps of:
detecting a fault at the apparatus;
when a fault is detected, placing the apparatus in a transition state whereby all active cleaning components are turned off;
rebooting the apparatus and performing a self-diagnostic check;
displaying a fault or incident screen with different menu options;
receiving input from the user on the menu options;
providing instructions to the processor of the apparatus to execute on an action related to the input; and
clearing the fault and resume operation when the fault is cleared.

2. The computer-implemented method of claim 1 further comprising the step of detecting whether the apparatus is operating in automatic or manual mode.

3. The computer-implemented method of claim 1 further comprising the step of displaying a message that a diagnostic check is in progress.

4. The computer-implemented method of claim 3 wherein the message for the diagnostic check displays a message that a self-health check is in progress.

5. The computer-implemented method of claim 1 wherein the menu options are selected from list consisting of:
displaying a list of incidents;
displaying instructions for each incident;
in manual mode, displaying a “Back” or “Hide” button;
in auto mode, displaying “Cancel Cleaning” and “Resume Cleaning” buttons or “Cancel” and “Resume” buttons;
displaying a “Manual Drive” button; and
displaying a “Help” button.

6. The computer-implemented method of claim 5 wherein if the “Manual Drive” option is selected, the apparatus displays the gear shifter icon and allows manual drive and then returns to the fault screen.

7. The computer-implemented method of claim 5 wherein if the “Resume cleaning” option is selected, the device checks to see if faults are still active and returns to the fault screen.

8. The computer-implemented method of claim 1 wherein incident notification can be provided with or without videos using hyperlinks based on the detected failure types, the hyperlinks are configured to specific contextual help videos next to each incident notification to further troubleshoot the incident.

9. The computer-implemented method of claim 8 wherein the videos can be accessed directly on the cleaning device graphical user interface (GUI) on the incident notification dashboard.

10. An incident notification system providing incident notification for a semi-autonomous cleaning apparatus, the incident notification system comprising:
a processor;
a display screen;
memory configured to store data related to incident notification;
wherein the processor is configured to execute instructions related to incident notification, the instructions further comprising the steps of:
detecting a fault at the apparatus;
when a fault is detected, placing the apparatus in a transition state whereby all active cleaning components are turned off;
rebooting the apparatus and performing a self-diagnostic check;
displaying a fault or incident on the display screen with different menu options;
receiving input from the user on the menu options;
providing instructions to the processor of the apparatus to execute on an action related to the input; and
clearing the fault and resume operation when the fault is cleared;
wherein storing data further comprises storing videos with or without hyperlinks.

11. The system of claim 10 further comprising a wireless receiver and transmitter to support cellular or Wifi communication.

12. The system of claim 10 wherein the display screen further comprises a dashboard configured to manage simultaneous faults in a single screen.

13. The system of claim 10 wherein the processor is further configured to execute the step of detecting whether the apparatus is operating in automatic or manual mode.

14. The system of claim 10 wherein the processor is further configured to execute the step of displaying a message that a diagnostic check is in progress.

15. The system of claim 10 wherein the menu options are selected from list consisting of:
displaying a list of incidents;
displaying instructions for each incident;
in manual mode, displaying a “Back” or “Hide” button;
in auto mode, displaying “Cancel Cleaning” and “Resume Cleaning” buttons or “Cancel” and “Resume” buttons;
displaying a “Manual Drive” button; and
displaying a “Help” button.

16. The system of claim 15 wherein if the “Manual Drive” option is selected, the apparatus displays the gear shifter icon and allows manual drive and then returns to the fault screen.

17. The system of claim 15 wherein if the “Resume cleaning” option is selected, the device checks to see if faults are still active and returns to the fault screen.

18. The system of claim 10 wherein the incident notification can be provided with or without videos using hyperlinks based on the detected failure types, the hyperlinks are configured to specific contextual help videos next to each incident notification to further troubleshoot the incident.

19. The system of claim 18 wherein the videos can be accessed directly on the cleaning device graphical user interface (GUI) on the incident notification dashboard.

20. The system of claim 10 wherein the processor is further configured to execute the step of detecting whether the apparatus is operating in automatic or manual mode.
